(19) United States
(12) Patent Application Publication
(10) Pub. No.: US 2011/0178678 A1
(43) Pub. Date: Jul. 21, 2011

(54) VEHICLE STATE MANAGEMENT SYSTEM, VEHICLE, VEHICLE STATE MANAGEMENT PROGRAM

(75) Inventor: Nobuaki Asahara, Saitama (JP)

(73) Assignee: HONDA MOTOT CO., LTD., Minato-ku, Tokyo (JP)

(21) Appl. No.: 12/920,583

(22) PCT Filed: Jan. 9, 2009
(86) PCT No.: PCT/JP2009/000072

§ 371 Date: Sep. 1, 2010

(30) Foreign Application Priority Data
Mar. 31, 2008 (JP) 2008-00042

(51) Int. Cl. G06F 7/00

(52) U.S. Cl. 701/36

(57) ABSTRACT

A system and the like capable of preventing the over discharge of the power source mounted on the vehicle, while alleviating the work for monitoring the power supply ability of the power source is provided. According to a vehicle state management system 10 of the present invention, a power supply ability of the power source 102 is evaluated at the point in time when the vehicle state management system 10 is transited from the operating state to the stand-by state. Thereafter, a transition requirement is set on the basis of the evaluation result, and the vehicle state management system 10 is transited from the stand-by state to the sleeping state at an appropriate time on condition that the transition requirement is satisfied, and the power supply from the power source 102 to a vehicle state communication system 10 is cut off.

### BACKGROUND OF THE INVENTION

1. Technical Field

The present invention relates to a system and the like which executes a designated task using equipments mounted on a vehicle, according to a request signal transmitted from outside.

2. Description of the Related Art

There is proposed a technique of cutting off a supply electricity to a wireless communication equipment, in the case where a predetermined condition is satisfied during a stand-by state in which the in-vehicle wireless communication equipment is capable of communicating, in order to prevent an over discharge of an in-vehicle battery or running out of the battery from the wireless communication equipment consuming an extremely small amount of power (refer to Japanese Patent Laid-Open No. H09-112393, Japanese Patent Laid-Open No. 2004-083002, and Japanese Patent Laid-Open No. 2004-093401).

However, it is necessary to constantly monitor a power supply ability of a power source, until the power supply from the power source to the wireless communication equipment is stopped.

### SUMMARY OF THE INVENTION

Therefore, an object of the present invention is to provide a system and the like which is capable of preventing over discharge of the power source mounted on a vehicle, while alleviating the work of monitoring the power supply ability of the power source.

In order to achieve the object mentioned above, a vehicle state management system of a first aspect of the invention is a vehicle state management system mounted on a vehicle, comprising: a wireless communication equipment; a task executing unit which executes a designated task by controlling an operation of a designated equipment among an equipment group mounted on the vehicle; and a state controlling unit which controls the vehicle state management system to any one of an operating state in which a second power is supplied from a power source to the vehicle state management system and the task executing unit is capable of executing the designated task, a stand-by state in which a first power which is smaller than the second power is supplied from the power source to the vehicle state management system and the wireless communication equipment is capable of communicating with an outside equipment and on the other hand the task executing unit is incapable of executing the designated task, and a sleeping state in which the power supply from the power source to the vehicle state management system is cut off and the wireless communication equipment is incapable of communicating with the outside equipment and also the task executing unit is incapable of executing the designated task, and which transmits the vehicle state management system from the operating state to the stand-by state on condition that an ignition switch or an accessory switch of the vehicle is switched from ON to OFF, transmits the vehicle state management system temporarily to the operating state on condition that an execution request signal of the designated task is received by the wireless communication equipment in the stand-by state, recognizes a power supply ability of the power source at the point in time when the vehicle state management system is transited from the operating state to the stand-by state, sets a transition requirement to the sleeping state on the basis of the power supply ability, and transits the vehicle state management system from the stand-by state to the sleeping state on condition that the transition requirement is satisfied.

According to the vehicle state management system of the first aspect of the invention, the power supply ability of the power source is evaluated at the point in time when the vehicle state management system is transited from the operating state to the stand-by state. Thereafter, the vehicle state management system is transited from the stand-by state to the sleeping state at an appropriate time in view of the evaluation result, and the power supply from the power source to a vehicle state communication system is cut off. Therefore, it becomes possible to prevent the over discharge of the power source mounted on the vehicle, while alleviating the work for monitoring the power supply ability of the power source.

Here, the term a component of the present invention “recognizes” information means that the component performs all possible information processing necessary for preparing or providing information for further information processing, such as the component receives the piece of information input from outside; searches the piece of information in an database; retrieves the piece of information from a storage device such as a memory; measures, calculates, estimates, determines the piece of information or the like on the basis of the output signals from sensors or the like; and stores in the memory the piece of measured information or the like.

The vehicle state management system of a second aspect of the invention is the vehicle state management system of the first aspect of the invention, wherein the state controlling unit sets a designated period to be shorter in a stepwise fashion or continuously as the power supply ability of the power source at the point in time when the vehicle state management system is transited from the operating state to the stand-by state is lower, and sets the fact that the designated period lapsed when the ignition switch or the accessory switch is continuously switched from ON to OFF, or the fact that the designated period lapsed while the vehicle state management system is maintained in the stand-by state, as the transition requirement.

According to the vehicle state management system of the second aspect of the invention, in view of the power supply ability of the power source at the point in time when the vehicle state management system is transited from the operating state to the stand-by state, the vehicle state management system may be transited from the stand-by state to the sleeping state, according to the fact that an appropriate period lapsed when the vehicle state management system is maintained in the stand-by state, and the like.

The vehicle state management system of a third aspect of the invention is the vehicle state management system of the first aspect of the invention, wherein the state controlling unit sets a permissible value of the consumed power to be lower as the power supply ability of the power source at the point in time when the vehicle state management system is transited from the operating state to the stand-by state is lower, and sets the fact that the consumed power by the vehicle state management system becomes equal to or more than the permissible value as the transition requirement.

According to the vehicle state management system of the third aspect of the invention, in view of the power supply ability of the power source at the point in time when the vehicle state management system is transited from the operating state to the stand-by state, the vehicle state management system may be transited from the stand-by state to the sleeping state, according to the fact that the consumed power by the vehicle state management system reached an appropriate value.

The vehicle state management system of a fourth aspect of the invention is the vehicle state management system according to any one of the first to the third aspect of the invention, wherein the state controlling unit corrects the transition requirement on the basis of consumed power required for executing the designated task by the task executing unit, in the case where the execution request signal of the designated task is received by the wireless communication equipment when the vehicle state management system is in the stand-by state.

According to the vehicle state management system of the fourth aspect of the invention, after the transition requirement from the stand-by state to the sleeping state is set as is mentioned above, the vehicle state management system is transited at an appropriate time in view of the power supply ability of the power source which dropped in order to execute the designated task.

A vehicle of a fifth aspect of the invention comprises an equipment group capable of executing a designated task as a designated equipment, the vehicle state management system of the first aspect of the invention, and a power source which supplies power to the vehicle state management system.

According to the vehicle of the fifth aspect of the invention, the over discharge of the power source mounted on the vehicle is prevented by the vehicle state management system, while alleviating the work for monitoring the power supply ability of the power source. Therefore, it becomes possible to avoid the situation where the function of the vehicle is impaired, such as the inability of starting the engine from lack of power supply from the power source to a starter.

A vehicle state management program of a sixth aspect of the invention makes a computer with a wireless communication equipment mounted on a vehicle equipped with an equipment group capable of executing a designated task as a designated equipment, and a power source, to function as the vehicle state management system of the first aspect of the invention.

According to the vehicle state management program of the sixth aspect of the invention, it becomes possible to make the in-vehicle computer to function as a system for preventing over discharge of the power source mounted on a vehicle, while alleviating the work for monitoring the power supply ability of the power source.

### BRIEF DESCRIPTION OF THE DRAWINGS

FIG. 1 is an explanatory view of a configuration of a vehicle and a vehicle state management system;

FIG. 2 is a flowchart showing a function of the vehicle state management system; and

FIG. 3 is an explanatory view of a state transition and consumed power of the vehicle state management system.

### DETAILED DESCRIPTION OF THE PREFERRED EMBODIMENTS

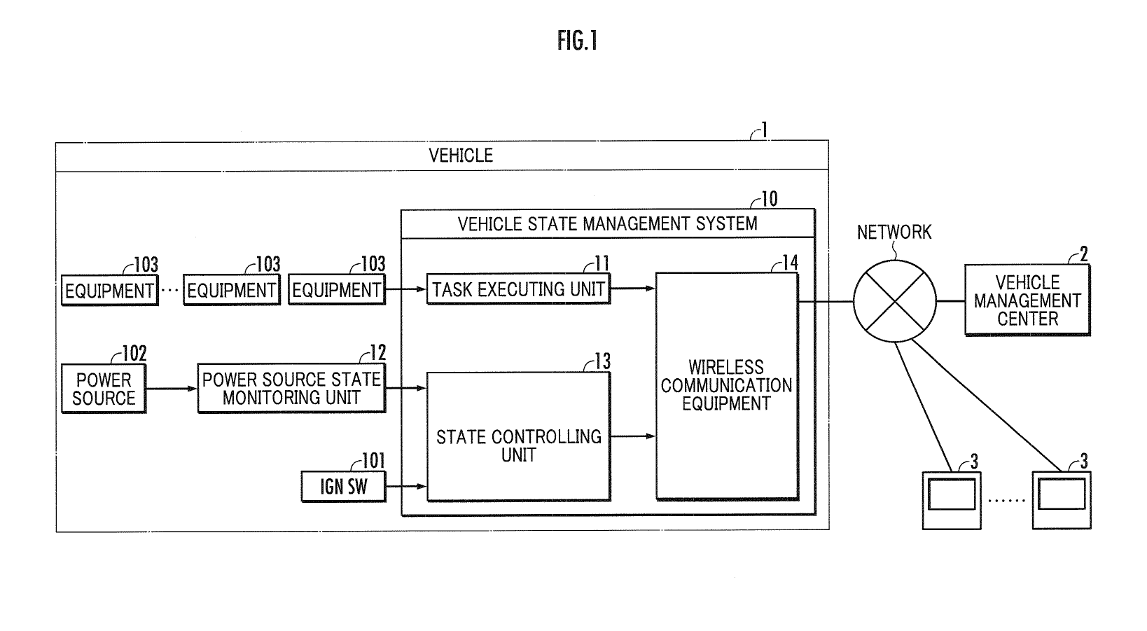

An embodiment of a vehicle state management system and the like of the present invention will now be explained below with reference to the accompanying drawings. A vehicle (four-wheel vehicle) 1 shown in FIG. 1 is equipped with an IGN (ignition) switch 101, a power source 102, a plurality of equipments 103 for executing tasks, a vehicle state management system 10, and a power source state monitoring unit 12 for measuring a power supply ability of the power source 102. The switching between ON and OFF of the IGN switch 101 initiates the switching of the state of the vehicle state management system 10 as will be explained later. In place of the IGN switch 101, the switching between ON and OFF of an ACC (accessory) switch may initiate the switching of the state of the vehicle state management system 10. The power source 102 supplies electric power to vehicle equipments such as the vehicle state management system 10 via a converter or a voltage adjustment unit according to need. A battery, a capacitor or a secondary battery, or a combination of the same, is mounted as the power source 102 on the vehicle 1. A plurality of the equipments 103 includes a door lock device, a window opening-closing device, an air-conditioning device, and a vehicle position measuring device and the like. The vehicle state management system 10 is configured from a computer or an electronic control unit (configured from a CPU, a ROM, a RAM, an I/O and the like). A vehicle state management program for making the computer function as the above-described system is stored in a memory of the computer configuring the vehicle state management system 10. The vehicle state management program may preliminary be stored in the memory, but may be installed to the computer via a recording medium such as a CD-ROM, or may be stored in the memory after receiving the same which is delivered or broadcasted from a server with a wireless communication equipment 14.

The vehicle state management system 10 is equipped with a task executing unit 11, a state controlling unit 13, and the wireless communication equipment 14. The task executing unit 11 executes a designated task by controlling an operation of the designated task among a plurality of the equipments 103. The wireless communication equipment 14 communicates with each of a vehicle management center 2 and a user terminal 3 via a network. The wireless communication equipment 14 may be mounted on the vehicle 1 independent of the electronic control unit constituting the vehicle state management system 10. Further, a portable-type communication equipment such as a cellular phone which is inserted to a cradle provided to the interior space of the vehicle 1 may be mounted on the vehicle 1 as the wireless communication equipment 14. The state controlling unit 13 controls the vehicle state management system 10 to either one state selected from “operating state”, “stand-by state”, and “sleeping state” as will be explained later. The “operating state” is a state in which a second power P₂ is supplied from the power source 102 to the vehicle state management system 10, and is a state in which the task executing unit 11 is capable of executing the designated task by controlling the operation of the designated equipment among a plurality of the equipments 103. The “stand-by state” is a state in which a first power P₁ which is smaller than the second power P₂ is supplied from the power source 102 to the vehicle state management system 10, and the wireless communication equipment 14 is capable of communicating with the outside equipment but the task executing unit 11 is incapable of executing the designated task. The “sleeping state” is a state in which a power supply from the power source 102 to the vehicle state management system 10 is cut off (a minute reference power P₀ which is substantially zero is being supplied to the vehicle state management system 10), and the wireless communication equipment 14 is incapable of communicating with the outside equipment and also the task executing unit 11 is incapable of executing the designated task.

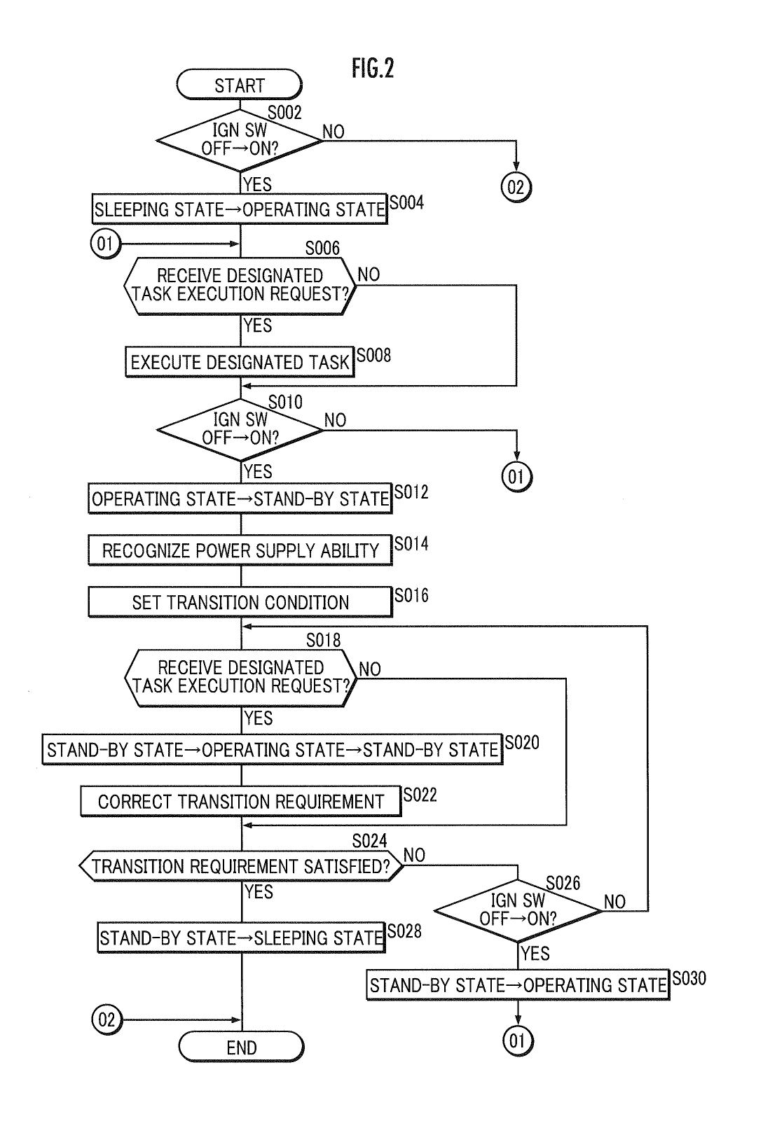

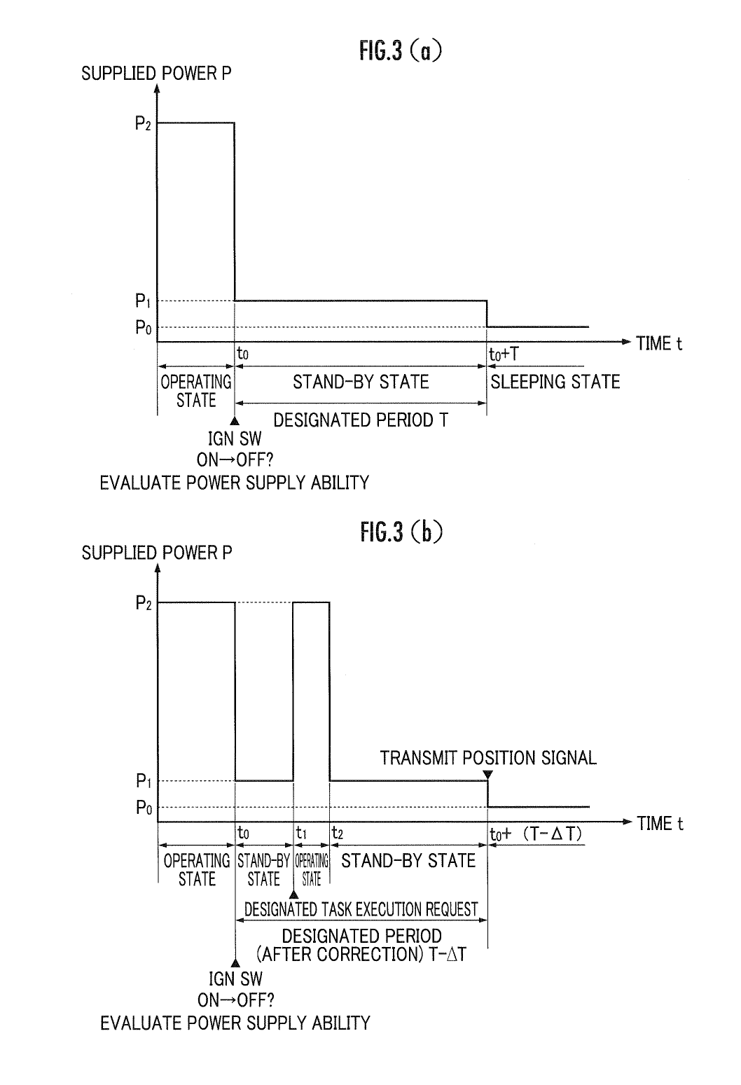

Next, explanation will be given on the function of the vehicle state management system 10 with the above-mentioned configuration. When the IGN switch 101 of the vehicle 1 is switched from OFF to ON (FIG. 2/S002 . . . YES), the state controlling unit 13 transits the wireless communication equipment 14 from the sleeping state to the operating state (FIG. 2/S004). By doing so, as is shown in FIG. 3, the supplied power P from the power source 102 to the vehicle state management system 10 is controlled to the second power P₂. Also, the task executing unit 11 determines the existence or nonexistence of an execution request of the designated task, that is, whether or not the wireless communication equipment 14 received the execution request signal of the designated task (FIG. 2/S006). In the case where it is determined that there is the execution request of the designated task (FIG. 2/S006 . . . YES), then the designated task is executed by the task executing unit 11 controlling the operation of the designated equipment 103 (FIG. 2/S008). Specifically, locking/unlocking of a door by the operation control of the door lock device, opening and closing of a window by the operation control of the window opening-closing device, starting/stopping of air-conditioning by the operation control of the air-conditioning device, or transmission of a position signal representing a measured vehicle position to a vehicle management center 2 or the like, by the operation control of the vehicle position measurement device and the wireless communication equipment 14, or a combination of these, is executed as the designated task. On the other hand, in the case where it is determined that there is no execution request of the designated task (FIG. 2/S006 . . . NO), then the designated task is not executed.

Thereafter, when the IGN switch 101 is switched from ON to OFF (FIG. 2/S010 . . . YES), the state controlling unit 13 transits the vehicle state management system 10 from the operating state to the stand-by state (FIG. 2/S012). By doing so, as is shown in FIG. 3(a) and (b), the supplied power P from the power source 102 to the vehicle state management system 10 from time t₀ is controlled to the first power P₁ (<P₂). Further, the power source state monitoring unit 12 measures or evaluates the power supply ability of the power source 102, and the state controlling unit 13 recognizes the power supply ability of the power source 102 at the point in time when the vehicle state management system 10 transits from the operating state to the stand-by state, by receiving the signal indicating the measurement result from the power source state monitoring unit 12 (FIG. 2/S014). Specifically, a SOC (state of charge) of the power source 102 is measured as the power supply ability. In the case where a fuel cell is mounted on the vehicle 1 and the power source 102 may be charged by the operation of the fuel cell, the power supply ability may be given comprehensive evaluation by taking into consideration the remaining amount of the fuel such as a hydrogen gas. In this case, the power supply ability may be given comprehensive evaluation by further taking into consideration a predicted consumed power by a pump which supplies fuel to the fuel cell. Further, the state controlling unit 13 sets a transition requirement on the basis of the power supply ability of the power source 102 at the point in time when the vehicle state management system 10 is switched from the operating state to the stand-by state (FIG. 2/S016). Specifically, the state controlling unit 13 sets a designated period to be shorter in a stepwise fashion or continuously, as the power supply ability of the power source 102 at this point in time is lower, and sets the fact that the designated period lapsed during when the IGN switch 101 is switched from ON to OFF, or the fact that the designated period lapsed during when the vehicle state management system 10 is maintained in the stand-by state as the transition requirement. In this case, a permissible value of the consumed power by the vehicle state management system 10 may be set to be lower as the power supply ability of the power source 102 at this point in time is lower, and the fact that the consumed power by the vehicle state management system 10 becomes equal to or larger than the permissible value may be set as the transition requirement, instead of or in addition to the transition requirement with respect to the lapse of the designated period.

Thereafter, when the vehicle state management system 10 is in the stand-by state, it is determined whether or not there is an execution request of the designated task (FIG. 2/S018). In the case where it is determined that the execution request of the designated task exists (FIG. 2/S018 . . . YES), then as is shown in FIG. 3(b), after the state controlling unit 13 temporarily transits the vehicle state management system 10 from the stand-by state to the operating state at time t₁, the vehicle state management system 10 is returned to the stand-by state at time t₂ (FIG. 2/S020). During the time when the vehicle state management system 10 is temporary transited to the operating state, the task executing unit 11 executes the designated task as is mentioned above. Further, the transition requirement is corrected on the basis of the predicted consumed power of the task executing unit 11 necessary for executing the designated task (FIG. 2/S022). Specifically, the transition requirement is corrected so that the designated period T becomes shorter or the permissible value of the consumed power becomes lower as the predicted consumed power becomes larger. On the basis thereof, whether or not the transition requirement of the vehicle state management system 10 to the sleeping state is satisfied, is determined (FIG. 2/S024). On the other hand, in the case where it is determined that there is no execution request of the designated task (FIG. 2/S018 . . . NO), then it is determined whether or not the transition requirement is satisfied while the vehicle state management system 10 is maintained in the stand-by state (FIG. 2/S024). In the case where it is determined that the transition requirement is satisfied (FIG. 2/S024 . . . YES), then the state controlling unit 13 switches the vehicle state management system 10 from the stand-by state to the sleeping state (FIG. 2/S028). By doing so, for example as is shown in FIG. 3(a), the supplied power P from the power source 102 to the vehicle state management system 10 from the time t₀+T is controlled to a reference power P₀ (substantially 0). Further, as is shown in FIG. 3(b), the supplied power P from the power source 102 to the vehicle state management system 10 from the time t₀+T−ΔT (ΔT represents a period of time shortened when correcting the transition requirement as is mentioned above) is controlled to the reference power P₀. On the other hand, in the case where it is determined that the transition requirement is not satisfied (FIG. 2/S024 . . . NO), then it is determined whether or not the IGN switch 101 is switched from OFF to ON (FIG. 2/S026). In the case where it is determined that the IGN switch 101 is switched from OFF to ON (FIG. 2/S026 . . . YES), then the state controlling unit 13 transits the vehicle state management system 10 from the stand-by state to the operating state (FIG. 2/S030), and the process after the determination on the existence or nonexistence of the execution request of the designated task is executed as is explained above (refer to FIG. 2/S006). In the case where it is determined that the IGN switch 101 is maintained OFF (FIG. 2/S026 . . . NO), then the process after the determination on the existence or nonexistence of the execution request of the designated task is repeated as is explained above (refer to FIG. 2/S018).

According to the vehicle state management system 10 exerting the above-mentioned functions, the power supply ability of the power source is evaluated at the point in time the vehicle state management system 10 is transited from the operating state to the stand-by state (refer to FIG. 2/S014, FIG. 3(a)(b)/time t₀). Thereafter, the transition requirement is set on the basis of the evaluation result, and on condition that the set requirement is satisfied, the vehicle state management system is transited from the stand-by state to the sleeping state, and the power supply from the power source 102 to a vehicle state communication system 10 is cut off (refer to FIG. 2/S016, S024, S028, FIG. 3(a)/time t₀+T). That is, the vehicle state management system 10 is transmitted from the stand-by state to the sleeping state at an appropriate time in view of the evaluation result, and the power supply from the power source 102 to the vehicle state communication system 10 is cut off. By doing so, it becomes possible to prevent over discharge of the power source 102, while alleviating the work of monitoring the power supply ability of the power source 102.

Further, in the case where the wireless communication equipment 14 receives the execution request signal of the designated task when the vehicle state management system 10 is in a stand-by state, the transition requirement is corrected on the basis of the consumed power necessary for executing the designated task by the task executing unit 11 (refer to FIG. 2/S018, S020, S022). By doing so, after setting the transition requirement from the stand-by state to the sleeping state as is mentioned above, it becomes possible to transit the vehicle state management system 10 to the sleeping state at an appropriate time in view of the power supply ability of the power source 102 which dropped in order to execute the designated task (refer to FIG. 2/S024, 5028, FIG. 3(b)/t₀+T−ΔT).

1. A vehicle state management system mounted on a vehicle, comprising:
a wireless communication equipment;
a task executing unit which executes a designated task by controlling an operation of a designated equipment among an equipment group mounted on the vehicle; and
a state controlling unit which controls the vehicle state management system to any one of an operating state in which a second power is supplied from a power source to the vehicle state management system and the task executing unit is capable of executing the designated task, a stand-by state in which a first power which is smaller than the second power is supplied from the power source to the vehicle state management system and the wireless communication equipment is capable of communicating with an outside equipment and on the other hand the task executing unit is incapable of executing the designated task, and a sleeping state in which the power supply from the power source to the vehicle state management system is cut off and the wireless communication equipment is incapable of communicating with the outside equipment and also the task executing unit is incapable of executing the designated task,
and which transmits the vehicle state management system from the operating state to the stand-by state on condition that an ignition switch or an accessory switch of the vehicle is switched from ON to OFF, transmits the vehicle state management system temporarily to the operating state on condition that an execution request signal of the designated task is received by the wireless communication equipment in the stand-by state, recognizes a power supply ability of the power source at the point in time when the vehicle state management system is transited from the operating state to the stand-by state, sets a transition requirement to the sleeping state on the basis of the power supply ability, and transits the vehicle state management system from the stand-by state to the sleeping state on condition that the transition requirement is satisfied.

2. The vehicle state management system according to claim 1,
wherein the state controlling unit sets a designated period to be shorter in a stepwise fashion or continuously as the power supply ability of the power source at the point in time when the vehicle state management system is transited from the operating state to the stand-by state is lower, and sets the fact that the designated period lapsed when the ignition switch or the accessory switch is continuously switched from ON to OFF, or the fact that the designated period lapsed while the vehicle state management system is maintained in the stand-by state, as the transition requirement.

3. The vehicle state management system according to claim 1,
wherein the state controlling unit sets a permissible value of the consumed power to be lower as the power supply ability of the power source at the point in time when the vehicle state management system is transited from the operating state to the stand-by state is lower, and sets the fact that the consumed power by the vehicle state management system becomes equal to or more than the permissible value as the transition requirement.

4. The vehicle state management system according to claim 1,
wherein the state controlling unit corrects the transition requirement on the basis of consumed power required for executing the designated task by the task executing unit, in the case where the execution request signal of the designated task is received by the wireless communication equipment when the vehicle state management system is in the stand-by state.

5. A vehicle, comprising an equipment group capable of executing a designated task as a designated equipment, the vehicle state management system according to claim 1, and a power source which supplies power to the vehicle state management system.

6. A vehicle state management program, which makes a computer with a wireless communication equipment mounted on a vehicle equipped with an equipment group capable of executing a designated task as a designated equipment, and a power source, to function as the vehicle state management system according to claim 1.
